(19) United States
(12) Patent Application Publication
(10) Pub. No.: US 2005/0283658 A1
(43) Pub. Date: Dec. 22, 2005

(54) Method, apparatus and program storage device for providing failover for high availability in an N-way shared-nothing cluster system

(76) Inventors: Thomas K. Clark, Gresham, OR (US); Austin F. D'Costa, Beaverton, OR (US); Sudhir G. Rao, Portland, OR (US); James J. Seeger, Portland, OR (US)

Correspondence Address: Chambliss, Bahner & Stophel, P.C., 1000 Tallan Building, Two Union Square, Chattanooga, TN, 37402, US

(21) Appl. No.: 10/850,749

(22) Filed: May 21, 2004

(51) Int. Cl. G06F 11/00

(52) U.S. Cl. 714/11

(57) ABSTRACT

A method, apparatus and program storage device for providing failover for continuous or near-continuous availability in an N-way logical shared-nothing cluster system is disclosed. Cluster application data space partitions are assigned to each node in the cluster and each node's or server software's internal architecture is partitioned in accordance with the application data partitions assigned to the node. Cluster-integrity protection is performed. A failover and recovery protocol is performed based upon the assigned partitions and the partitioned and bound internal architecture. Containment of the impact of failure is provided such that most of the application data space partitions are not impacted. Affected partition sets are failed over fast and in constant time and so actual load on the surviving nodes does not affect failover duration. When shared storage is not provided, synchronous log replication may be used to facilitate failover and log-based recovery.

### BACKGROUND OF THE INVENTION

1. Field of the Invention

This disclosure relates in general to parallel computer architectures, and more particularly to a method, apparatus and program storage device for providing failover for continuous or near-continuous availability in an N-way shared-nothing cluster system.

2. Description of Related Art

Computer architectures often have a plurality of logical sites that perform various functions. One or more logical sites, for instance, include a processor, memory, input/output devices, and the communication channels that connect them. Information is typically stored in a memory. This information can be accessed by other parts of the system. During normal operations, memory provides instructions and data to the processor, and at other times the memory is the source or destination of data transferred by I/O devices.

Input/output (I/O) devices transfer information between at least one internal component and the external universe without altering the information. I/O devices can be secondary memories, for example disks and tapes, or devices used to communicate directly with users, such as video displays, keyboards, touch screens, etc.

The processor executes a program by performing arithmetic and logical operations on data. Modern high performance systems, for example vector processors and parallel processors, often have more than one processor. Systems with only one processor are serial processors, or, especially among computational scientists, scalar processors. The communication channels that tie the system together can either be simple links that connect two devices or more complex switches that interconnect several components and allow any two of them to communicate at a given point in time.

A parallel computer is a collection of processors that cooperate and communicate to solve large problems fast. Parallel computer architectures extend traditional computer architecture with a communication architecture and provide abstractions at the hardware/software interface and organizational structure to realize abstraction efficiently. Parallel computing involves the simultaneous execution of the same task (split up and specially adapted) on multiple processors in order to obtain faster results.

There currently exist several hardware implementations for parallel computing systems, including but not necessarily limited to a shared-memory approach, a shared-disk approach and a shared-nothing approach. In the shared-memory approach, processors are connected to common memory resources. All inter-processor communication can be achieved through the use of shared memory. This is one of the most common architectures used by systems vendors. However, memory bus bandwidth can limit the scalability of systems with this type of architecture.

In a shared-disk approach, processors have their own local memory, but are connected to common disk storage resources; inter-processor communication is achieved through the use of messages and file lock synchronization. However, I/O channel bandwidth can limit the scalability of systems with this type of architecture.

In a physical shared-nothing approach, processors have their own local memory and their own direct access storage device (DASD) such as a disk. Thus, where a first cluster node owns a physical disk, no other cluster node can access the physical disk and the first cluster node has exclusive ownership of this shared disk until it is either manually moved to another cluster node, or until the first node fails and another cluster node assumes ownership of the resource. All inter-processor communication is achieved through the use of messages transmitted over a network protocol. A given processor, in operative combination with its memory and disk comprises an individual network node. This type of system architecture is referred to as a massively parallel processor system (MPP). One problem with a shared-nothing architecture in which information is distributed over multiple nodes is that it typically cannot operate very well if any of the nodes fail because then some of the distributed information is not available anymore. Transactions that need to access data at a failed node cannot proceed. If database relations are partitioned across all nodes, almost no transaction can proceed when a node has failed.

A physical shared-nothing architecture is to be distinguished from a logical shared-nothing architecture. For example, in the context of clusters, there are two approaches to distributing and balancing the workload. In a first approach, a full shared data space model is used where every node can access all data. In the full shared data space model, data access is controlled via distributed locking. The second approach is the logical shared-nothing architecture. The logical shared-nothing architecture involves partitioning of the data space, and each node works on a subset or partition of the data space. The physical shared disk and logical shared-nothing provides advantages in scalability and failovers.

A computer cluster is a group of connected computers that work together as a parallel computer. All cluster implementations attempt to eliminate single points of failure. Moreover, clustering is used for parallel processing, load balancing and fault tolerance and is a popular strategy for implementing parallel processing applications because it enables companies to leverage the investment already made in PCs and workstations. In addition, it's relatively easy to add new CPUs simply by adding a new PC to the network. A “clustered” computer system can thus be defined as a collection of computer resources having some redundant elements. These redundant elements provide flexibility for load balancing among the elements, or for failover from one element to another, should one of the elements fail. From the viewpoint of users outside the cluster, these load-balancing or failover operations are ideally transparent. For example, a mail server associated with a given Local Area Network (LAN) might be implemented as a cluster, with several mail servers coupled together to provide uninterrupted mail service by utilizing redundant computing resources to handle load variations for server failures.

Within a cluster, the likelihood of a node failure increases with the number of nodes. Furthermore, there are a number of different types of failures that can result in failure of a single node. Examples of failures that can result in failure of a single node include processor failure at a node, a non-volatile storage device or controller for such a device failure at a node, a software crash occurring at a node or a communication failure occurrence that results in all other nodes losing communication with a node. In order to provide high availability (i.e., continued operation) even in the presence of a node failure, information is commonly replicated at more than one node, so that in the event of a failure of a node, the information stored at that failed node can be obtained instead at another node which has not failed.

Continuous or near-continuous availability requirements are increasingly placed on the recovery characteristics of cluster architecture based products. High availability architectures include multiple redundant monitoring topologies that provide multiple data points for fault detection to help reduce the fault detection time. For example, dual ring or triple ring heartbeat-based monitoring topologies (that require or exploit dual networks, for instance) can reduce failure detection time significantly. However, these have no impact on cluster or application recovery time except for minimizing network fault related impact. Further, these architectures increase the cost of the clustered application.

“Pure” or symmetric cluster application architecture uses a “pure” cluster model where every node is homogeneous and there is no static or dynamic partitioning of the application resource or data space. In other words, every node can process any request from a client of the clustered application. This architecture, along with a load balancing feature, has intrinsic fast-recovery characteristics because application recovery is bounded only by cluster recovery with implied recovery of locks held by the failed node. Although symmetric cluster application architectures have good characteristics, symmetric cluster application architectures involve distributed lock management requirements that can increase the complexity of the solution and can also affect scalability of the architecture.

Partitioned or logical “shared-nothing” cluster application architectures employ static or even dynamic partitioning of the application resource or data space with each node servicing requests for the partition(s) that it owns. Each node may have its own log(s) for transactional consistency and data recovery. In this architecture, the cost of the application recovery also includes the cost of log-based recovery. The shared-nothing architecture bears an increased cost for application recovery. Synchronous logging or aggressive buffer cache flushing can be used to reduce recovery time. However, both of these affect steady state performance. Some other solutions use a synchronous log replication scheme between pairs of nodes thus allowing the sibling node to take over from where the failed node left off. However, synchronous log replication adds to the cost and complexity of the solution.

Unlike symmetric clustered applications that use a “pure” cluster model with homogeneous nodes, where any node can service any request, the availability and failover requirements placed on shared-nothing or partitioned cluster application architectures in a shared storage environment frequently get side-lined vis-a-vis steady state performance, load balancing, and scaling. In some products, expensive and complex topologies and hardware, which could include usage of a shared non-volatile RAM between nodes for shared log-record access, may get used in order to provide such continuous or near-continuous characteristics. Imparting the above properties to a clustered application requires high availability architecture changes, clustered application architecture changes and/or cluster failover protocol changes.

It can be seen that there is a need for a method, apparatus and program storage device for providing failover for continuous or near-continuous availability in an N-way shared-nothing cluster system.

### SUMMARY OF THE INVENTION

To overcome the limitations described above, and to overcome other limitations that will become apparent upon reading and understanding the present specification, the present invention discloses a method, apparatus and program storage device for providing failover for continuous or near-continuous availability in an N-way shared-nothing cluster system.

The present invention solves the above-described problems by assigning cluster application data space partitions to each node in the cluster and partitioning a node's or server software's internal architecture in accordance with the application data partitions assigned to the node. Cluster-integrity protection is performed. A failover and recovery protocol is performed based upon the assigned partitions and the scoped internal architecture. Containment of the impact of failure is provided such that most of the application data space partitions are not impacted. Affected partition sets are failed over fast and in constant time and so actual load on the surviving nodes does not affect failover duration. When shared storage is not provided, synchronous log replication may be used to facilitate failover and log-based recovery.

A program storage device in accordance with the principles of the present invention includes program instructions executable by a processing device to perform operations for providing continuous or near-continuous availability in an N-way shared-nothing cluster system, the operations including assigning cluster application data space partitions to each node in a cluster and partitioning and binding internal architecture to the cluster application data space partitions assigned to the node.

In another embodiment of the present invention, a computing device for use in a N-way shared-nothing cluster system is provided. The computing device includes memory for storing data therein and a processor, coupled to the memory, the processor configured to perform an operation by assigning cluster application data space partitions, and partitioning and binding internal architecture to the cluster application data space partitions.

In another embodiment of the present invention, a method providing failover for continuous or near-continuous availability in an N-way shared-nothing cluster system is provided. The method includes assigning cluster application data space partitions to each node in a cluster and partitioning and binding internal architecture to the cluster application data space partitions assigned to the node.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a clustered processing system according to an embodiment of the present invention;

FIG. 2 is illustrates the partitioning for a logical shared-nothing cluster system according to an embodiment of the present invention;

FIG. 3 illustrates the partitioning for a physical shared-nothing cluster system according to an embodiment of the present invention;

FIG. 4 is a flow chart of a method for providing continuous or near-continuous availability in an N-way shared-nothing cluster system and for performing fast failover in an N-way shared-nothing cluster system according to an embodiment of the present invention;

FIG. 5 is a flow chart showing further details of performing cluster-integrity protection of FIG. 4 according to an embodiment of the present invention;

FIG. 6 is a flow chart showing further details of the performing of recovery protocol of FIG. 4 according to an embodiment of the present invention;

FIG. 7 is a flow chart showing details of the cluster membership validation and teardown of affected file sets of FIG. 6 according to an embodiment of the present invention;

FIG. 8 illustrates a simple diagram illustrating synchronous replication according to an embodiment of the present invention;

FIG. 9 illustrates a simple diagram illustrating log-based recovery according to an embodiment of the present invention; and

FIG. 10 illustrates an example of a suitable computing system environment according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, apparatus and program storage device for providing failover for high availability system architecture for cluster applications on a logical or physical shared-nothing cluster architecture. The present invention assigns cluster application data space partitions to each node in the cluster and partitions node's or server software's internal architecture in accordance with the application data partitions assigned to the node. In scoping each node's or server software's internal architecture to the cluster application data partitions assigned to the node, transaction queues, logs, buffers and synchronization primitives of a node are partitioned and bound to cluster application data partitions assigned to the node to provide separate and non-overlapping transactional pipelines for each partition. Cluster-integrity protection is performed. A failover and recovery protocol is performed based upon the assigned partitions and the scoped internal architecture. Containment of the impact of failure is provided such that most of the application data space partitions are not impacted. Affected partition sets are failed over fast and in constant time and so actual load on the surviving nodes does not affect failover duration. When shared storage is not provided, synchronous log replication may be used to facilitate failover and log-based recovery.

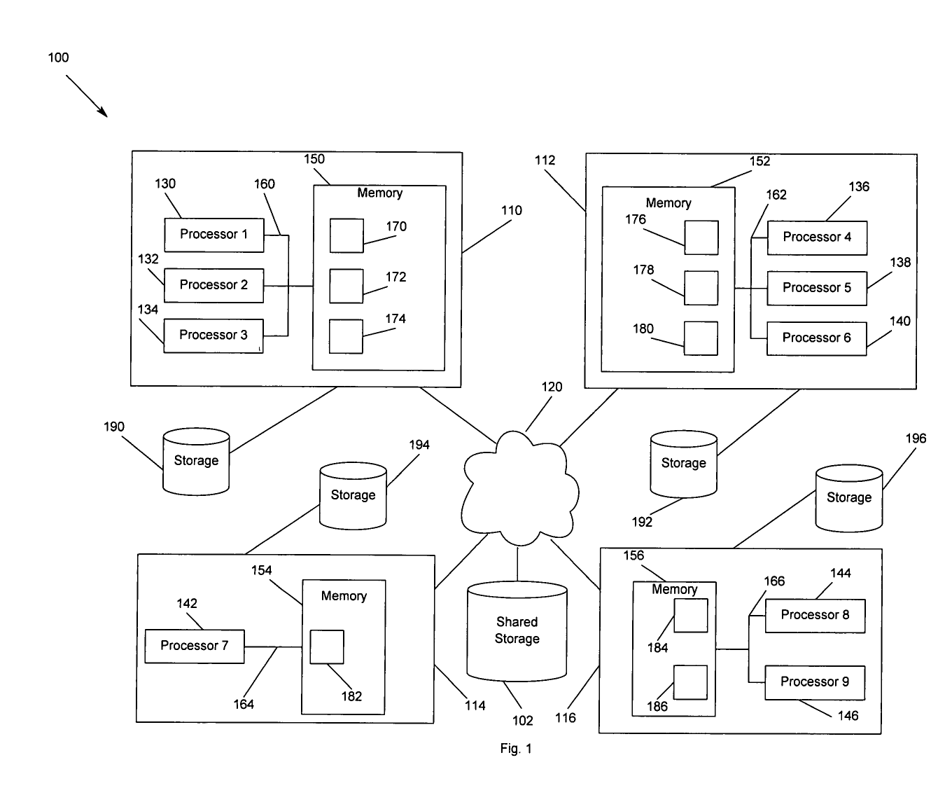

FIG. 1 illustrates a clustered processing system 100 according to an embodiment of the present invention. In FIG. 1, the clustered processing system 100 includes nodes 110-116 interconnected by a communication network 120. Although only four nodes 110-116 are shown, it will be evident to those skilled in the art that more nodes can be included. The cluster system 100, for example, may be designed for sixteen nodes. Also, the communication network 120 may use a router-based system area network configuration. However, other network configurations can be used (e.g., Token Ring, FDDI, Ethernet, etc.).

Each node 110-116 includes at least one processor units 130-146 coupled to memory elements 150-156 by bus structures 160-166. Each of the nodes 110-116 may include at least one processor unit 130-146 as shown, although more may be used in an expanded design. Nevertheless, FIG. 1 shows a maximum of three processor units 130-134, 136-140 for nodes 110 and 112 respectively to preclude unduly complicating the figures and discussion. As such, the nodes 110, 112, and 116 have multiple processor units 130-134, 136-140 and 144-146 respectively. However, there may be at least one node (e.g., node 114) with only a single processor unit 142. Memory segment areas 170-186 may be provided in the memory element 150-156 specifically for a processor unit for mutual exclusive access to that memory segment area 170-186. Storage devices 190-196 may be “owned” by nodes 110-116 so that nodes 110-116 only have access to the storage devices 190-196 that they own. Each storage device 190-196 may represent a plurality of storage devices. Shared storage 102 may be provided for the cluster so that each node 110-116 has access to the shared storage 102.

A node 110-116 may fail affecting at least one partition of the resource or data space. The failed node 110-116 is referred to as a rogue server since it can potentially perform some latent I/Os on the partitions bound to it. Partitions that need to be failed over are termed as affected partitions. Unaffected partitions are partitions that do not need to be failed over. When a partition is affected, a failover operation is performed.

However, unlike symmetric clustered applications that use a “pure” cluster model with homogeneous nodes, where any node can service any request, the availability and failover requirements placed on shared-nothing or partitioned cluster application architectures in a shared storage environment frequently get side-lined vis-a-vis steady state performance, load balancing, and scaling. Accordingly, the present invention provides a scalable failover architecture and recovery protocol model in a partitioned or logical “shared-nothing” clustered application architecture 100 that provides continuous and near-continuous availability characteristics.

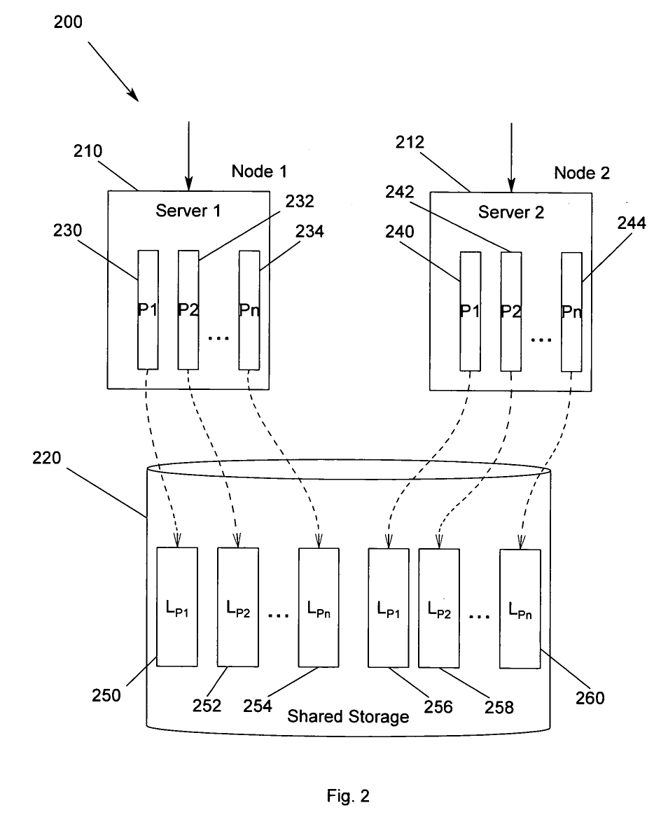

FIG. 2 illustrates the partitioning for a logical shared-nothing cluster system 200 according to an embodiment of the present invention. In FIG. 2, two servers 210, 212 are shown coupled to a shared storage device 220. The first server 210 is a first cluster node and the second server 212 is a second cluster node. Those skilled in the art will recognize that there may be many more nodes in a cluster. The first server includes memory partitions 230-234. The second server includes memory partitions 240-244. The shared storage device 220 includes log files 250-260 associated with each partition 230-234 and 240-244. Thus, the architecture 200 shown in FIG. 2 represents a shared storage/logical shared-nothing architecture. The architecture is a logical shared-nothing because P1 230, 240 could map to an “Accounts” database or file system subspace in application data space partitions, while P2 232, 242 could map to a “Marketing” database or file system subspace. Thus, a server/node 210, 212 may have one or more partitions.

For a logical shared-nothing architecture, for failover to occur, e.g., failed first server/node 210 to the second server/node 212, the second server/node 212 needs access to logs and data space (not shown) of the first server/node 210. With shared storage 220 as shown in FIG. 2, this is possible. Hence, the shared storage/logical shared-nothing architecture 200 represents one embodiment of the present invention.

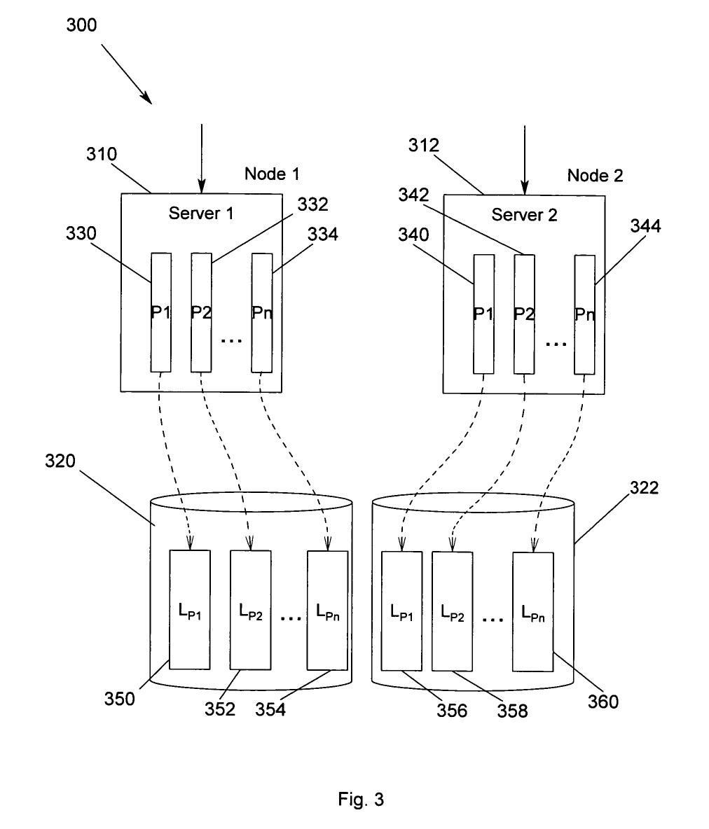

FIG. 3 illustrates the partitioning for a physical shared-nothing cluster system 300 according to an embodiment of the present invention. In FIG. 3, two servers 310, 312 are shown coupled to their own storage devices 320, 322 respectively. Again, the first server 310 is a first cluster node and the second server 312 is a second cluster node, while there may be many more nodes in a cluster. The first server includes partitions 330-334. The second server includes partitions 340-344. The storage device 320 includes log files 350-354 associated with partition 330-334. Storage device 322 includes log files 356-360 associated with partition 340-344.

For a physical shared-nothing architecture, for failover to occur, e.g., failed first server/node 310 to the second server/node 312, the second server/node 312 needs synchronous log record access from the logs 350-354 of first server/node 310 to replicate log and data in its own storage device 322. By providing the second server/node 312 synchronous log record access from the logs 350-354 of first server/node 310 failover is still possible.

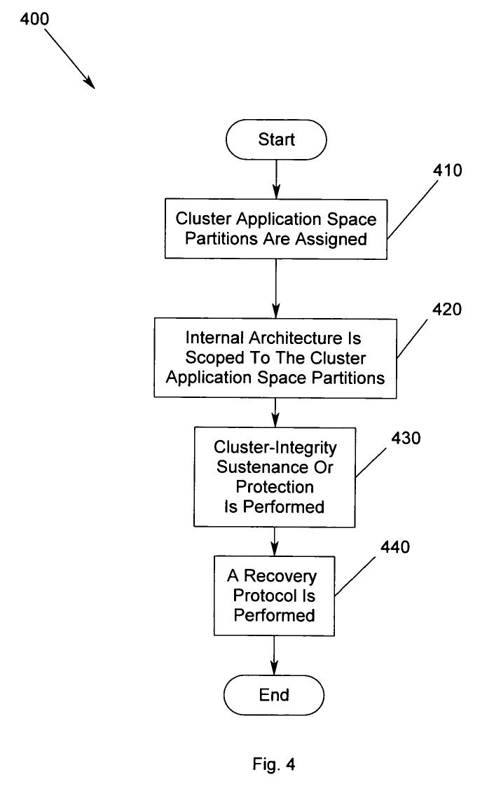

FIG. 4 is a flow chart 400 of a method for providing continuous or near-continuous availability in an N-way shared-nothing cluster system and for performing fast failover in an N-way shared-nothing cluster system according to an embodiment of the present invention. In FIG. 4, to provide high availability in an N-way shared-nothing cluster system, the total cluster application data space is first partitioned and the partitions are assigned to nodes (410). The application data space partitions could be statically assigned or dynamically assigned to a node. Partitions could in practice be statically assigned to nodes by the user. Users may choose to statically assign partitions and optionally leave some partitions as dynamic in order to provide load balancing flexibility to the system. Alternatively, partitions could be dynamically assigned to nodes by the system. Partitions of a failed node could be dynamically assigned by the system to any node based on criteria (typically, load balancing criteria). However, load balancing is not central to an embodiment of the present invention. The application data space partitions are chosen not only for ease of use and load balancing, but also to limit and contain failover impact to affected static and dynamic partitions. An affected static partition is treated as a dynamic partition that can be re-assigned by the system to another node. Unaffected static partitions virtually have no failover impact owing to the internal scoped architecture where the internal structures for transaction queues, logs, buffers, and synchronization primitives are scoped to these partitions; thus exhibiting high availability characteristics.

Next, the node's or server software's internal architecture is scoped to the cluster application data space partitions assigned to that node (420). For instance, if a node is assigned 4 application data space partitions, then its architecture would be dynamically restructured to have 4 internal partitions each one self-contained with associated log, buffer, synchronization primitives, transaction queues, etc. The scoping of the internal architecture to the cluster application data space partitions is scalable. Partition-scoped logs, transaction queues, buffer cache, and associated synchronization primitives reduce contention between transactions that operate on different partitions unless they span two or more partitions (which is rare in most applications). Reducing contention allows the transactions on the unaffected partitions to continue unhindered providing continuous availability of these partitions. The failover of the work-load including the log for affected partitions to at least one surviving node involves just changing the partition-node bindings and creating the context for transaction queue, buffer cache and so on, which can be created fast and in constant time.

In providing failover, cluster-integrity sustenance or protection is performed (430). Conventional cluster model semantics dissolves the cluster and makes the entire application temporarily unavailable during cluster recovery. Cluster dissolution implies unavailability of application service during that brief period because application data integrity is directly tied to cluster integrity. This is primarily because the heartbeat-based monitoring topology changes when the cluster membership changes. However, according to an embodiment of the present invention, the cluster is not entirely dissolved during cluster recovery while still protecting cluster integrity. A recovery protocol is then performed (440). The recovery protocol exploits the partitioning scheme and the internal architecture of the system.

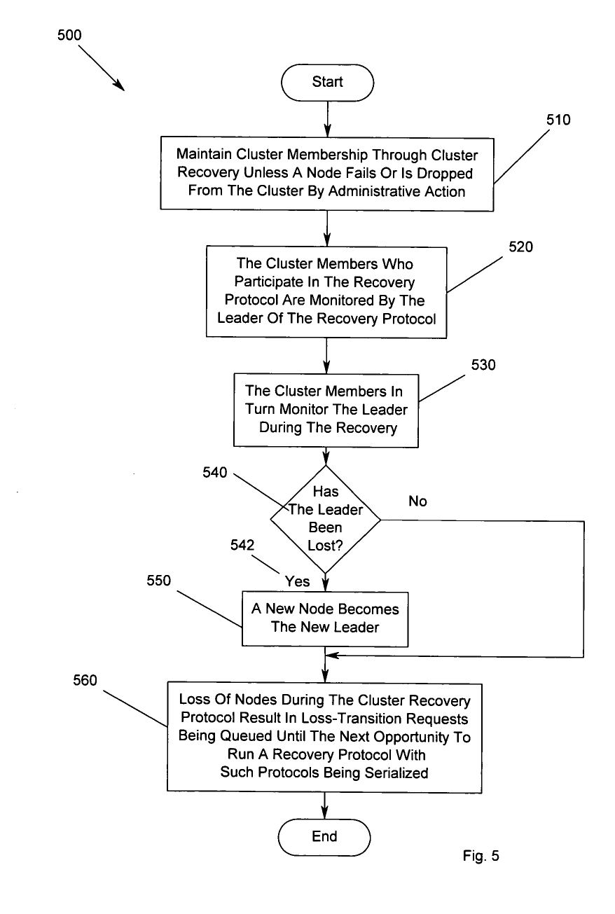

FIG. 5 is a flow chart 500 showing further details of performing cluster-integrity protection of FIG. 4 according to an embodiment of the present invention. Cluster membership semantics provides for a member node being permanently in the cluster even during cluster recovery unless it fails during cluster recovery or is dropped from the cluster by administrative action (510). In the absence of heartbeats, the cluster members that participate in the recovery protocol are monitored by the coordinator, i.e., the leader, of the recovery protocol (520). The cluster members in turn monitor the leader thus providing a closed-loop recovery and monitoring method that preserves cluster integrity (530). A determination is made whether the leader is lost (540). Loss of the leader (542) results in a new node becoming the new leader (550). Loss of non-leader nodes during the cluster recovery protocol may need to result in loss-transition requests being queued until the next opportunity to run a failover and recovery protocol (560). Such protocols are serialized. This process maintains the integrity of the cluster and enables an application on an unaffected node to continuously service transactions for unaffected partitions. Thus, by providing closed-loop cluster membership monitoring and serialized queuing of loss-transition requests, the cluster integrity is maintained.

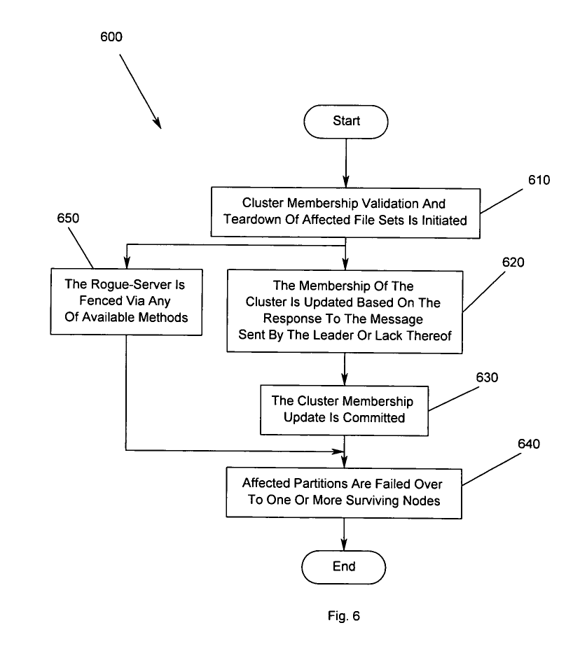

FIG. 6 is a flow chart 600 showing further details of the performing of recovery protocol of FIG. 4 according to an embodiment of the present invention. First, before failing over affected partitions, cluster membership validation and teardown of affected file sets is initiated (610). Cluster membership validation involves confirming that a node is still connected. File set teardown requires the release of resources and resetting state values for affected partitions. Next, the membership of the cluster is updated based on the response to the message sent by the leader or lack thereof (620). The updated cluster membership is then committed (630). The cluster leader will commit the membership update if it receives responses from all those expected to be in the new cluster view. Affected partitions are partitions that belong to failed nodes. Affected partitions are failed over to at least one surviving node (640). Each node that receives a failover partition performs log-based recovery on the received partition if synchronous log and data replication is not supported. In order to minimize the failover time, when the failed node or rogue server set is known, the fencing of the rogue-server (650) is initiated in parallel with the cluster membership updating (620). The fencing of the rogue server is completed by the time the recovery protocol of step (640) is initiated. All of the elements presented herein contribute to continuous availability of unaffected static partitions while providing near-continuous availability characteristics for affected partitions (whether static or dynamic).

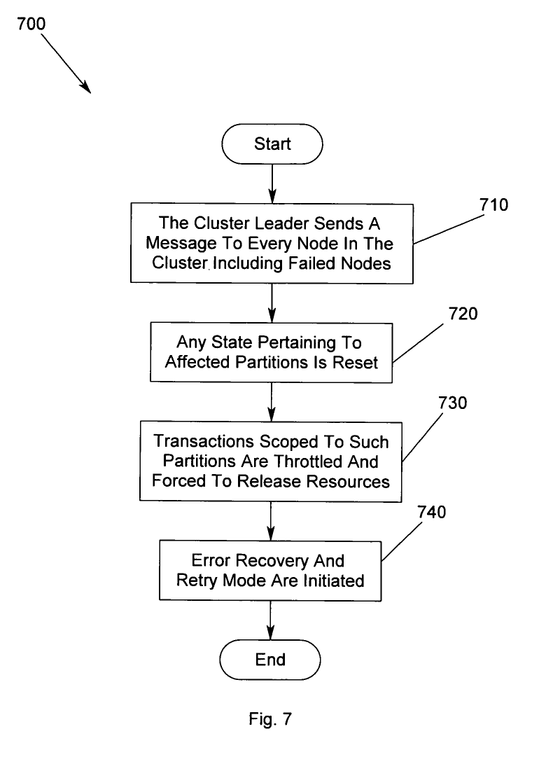

FIG. 7 is a flow chart 700 showing details of the cluster membership validation and teardown of affected file sets of FIG. 6 according to an embodiment of the present invention. During cluster membership validation and affected file set teardown, the cluster leader sends a message to every node in the cluster including failed nodes (710). Sending a message to failed nodes validates the connectivity or loss of connectivity with failed nodes. This helps increase the reliability of failure detection with reduced failure detection times even without the use of multiple heartbeat channels. All nodes respond to this message with a response message. Logical states pertaining to affected partitions are reset (720), transactions scoped to such partitions are throttled and forced to release resources (730) and error recovery and retry mode are initiated (740). In throttling transactions partitioned and bound to affected partitions, processes associated with the affected partitions are regulated or halted. Resources are then released so that the resources can be made available again. In scoping each node's or server software's internal architecture to the cluster application data partitions assigned to the node, transaction queues, logs, buffers and synchronization primitives of a node are partitioned and bound to cluster application data partitions assigned to the node to provide separate transactional pipelines for each partition. The forced release of resources may be performed using disk-based protocols if the network path is affected.

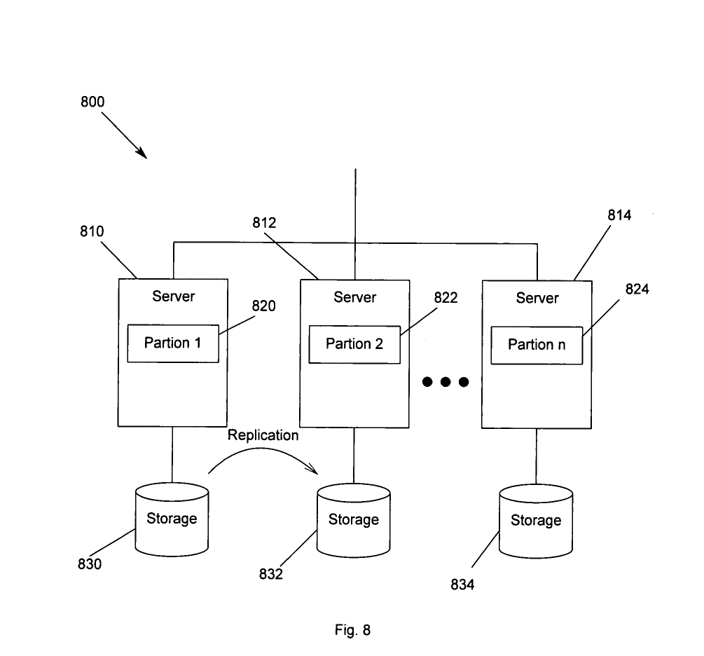

FIG. 8 illustrates a simple diagram illustrating synchronous replication 800 according to an embodiment of the present invention. In FIG. 8, three servers or nodes 810-814 are coupled in a shared-nothing architecture. Each node 810-814 is assigned or bound with a partition 820-824 of, for example, a database file or application name space. All service requests on a partition 820-824 are directed to a node 810-814 bound to that partition 820-824. Each of the nodes 810-814 are structured to employ a “shared-nothing” concept, wherein each node 810-814 is a separate, independent, computing system with its own storage devices 830-834. Each storage system 830-834 may represent a plurality of storage devices.

Using a database application as an example, database activity is based on being able to “commit” updates to a database. A commit point is when database updates become permanent. Commit points are events at which all database updates produced since the last commit point are made permanent parts of the database. Synchronous replication ensures that each node that receives a failover partition performs updates to a secondary node and acknowledged before the update operation completes. This way, in the event of a disaster at the primary location, data recovered from any surviving secondary server is completely up to date because all servers share the exact same data state. Synchronous replication produces full data currency, but may impact application performance in high latency or limited bandwidth situations.

In FIG. 8, data is sent to a first partition 820. The data is sent and committed to a second partition 822 before the update operation completes. Thus, the data in the first partition 820 is written to the second partition 822. The second server sends an acknowledgement of the write completion to the first server 810. The first server 810 associated with the first partition 820 may send an acknowledgement to a client (not shown) to complete the input/output procedure. Thus, the partition 820 is replicated before further database updates are initiated. Those skilled in the art will recognize that embodiments of the present invention are not meant to be limited to the particular hardware configuration and partitioning shown in FIG. 8.

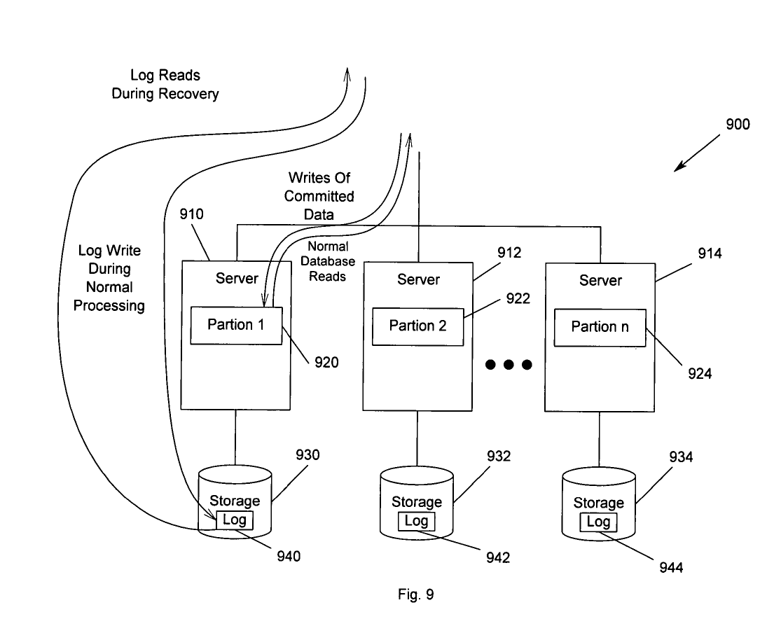

FIG. 9 illustrates a simple diagram illustrating log-based recovery 900 according to an embodiment of the present invention. In FIG. 9, three servers or nodes 910-914 are coupled in a physical shared-nothing architecture. However, those skilled in the art will recognize that log-based recovery 900 according to an embodiment of the present invention applies to shared storage as well. In FIG. 9, each node 910-914 is assigned or bound with a partition 920-924 of, for example, a database file or application name space. All service requests on a partition 920-924 are directed to a node 910-914 bound to that partition 920-924. Each of the nodes 910-914 are structured to employ a “shared-nothing” concept, wherein each node 910-914 is a separate, independent, computing system with its own storage devices 930-934. Each storage system 930-934 may represent a plurality of storage devices.

Further, each storage system 930-934 includes a log file 940-944. A transaction's updates for partition 920 are written to the log 940 and update propagation to the partition 920 is deferred until after the transaction successfully commits. Each update for partition 920 causes a record to be written to log buffer 940. A record may include the updated data, the data's location and the identifier of the transaction that performed the update. When a transaction commits, all update records are flushed to the log 940. The transaction is committed by writing a commit entry to the log 940. The transaction's updates are propagated to the partition 920 any time after the transaction commits. The log 940 is read during database recovery operations to commit completed transactions and rollback incomplete transactions.

To summarize, in some embodiment of the present invention, a partitioning and partition assignment scheme for the application data space and system internal architecture is provided along with recovery protocols to provide the above characteristics. Some embodiments of the present invention provide containment of failure-impact, cluster integrity protection during recovery, fast and scalable non-disruptive failover and prevention of data corruption. Embodiments of the present invention provide containment of the impact of failure such that most of the application data space partitions are not impacted. Affected partition sets are failed over fast and in constant time and so actual load on the surviving nodes does not affect failover duration. The architecture and protocol model are designed to prevent data corruption as a result of rogue servers and application errors higher up in the application stack as a result of in-flight transactions and messages.

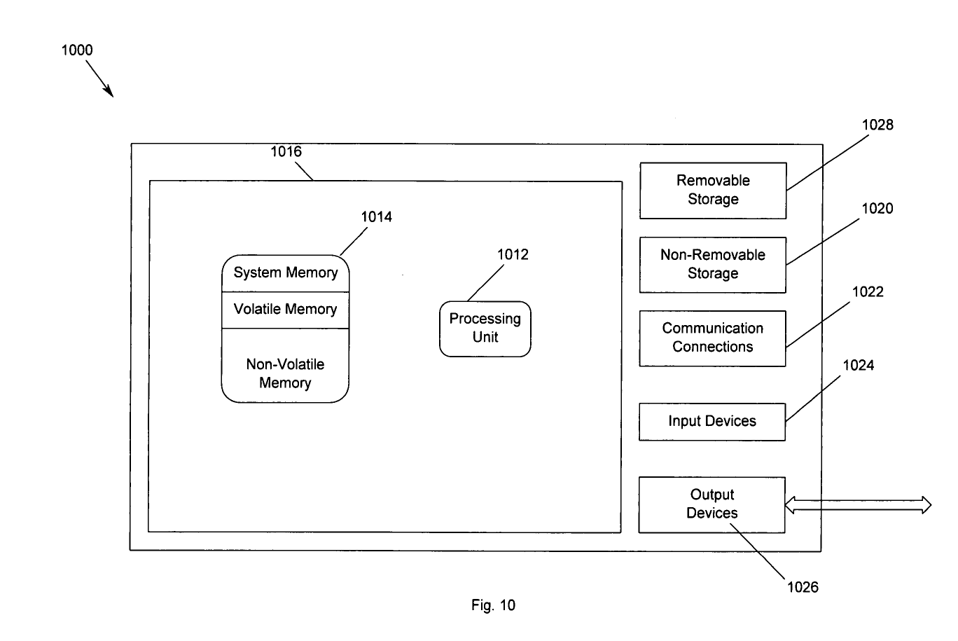

FIG. 10 illustrates an example of a suitable computing system environment 1000 according to an embodiment of the present invention. For example, the environment 1000 can be a client, a data server, and/or a master server that has been described. The computing system environment 1000 is only one example of a suitable computing environment and is not intended to suggest any limitation as to the scope of use or functionality of the invention. Neither should the computing environment 1000 be interpreted as having any dependency or requirement relating to any one or combination of components illustrated in the exemplary operating environment 1000. In particular, the environment 1000 is an example of a computerized device that can implement the servers, clients, or other nodes that have been described.

An exemplary system for implementing the invention includes a computing device, such as computing device 1000. In its most basic configuration, computing device 1000 typically includes at least one processing unit 1012 and memory 1014. Depending on the exact configuration and type of computing device, memory 1014 may be volatile (such as RAM), non-volatile (such as ROM, flash memory, etc.) or some combination of the two. This most basic configuration is illustrated by dashed line 1016. Additionally, device 1000 may also have additional features/functionality. For example, device 1000 may also include additional storage (removable and/or non-removable) including, but not limited to, magnetic or optical disks or tape. Such additional storage is illustrated in by removable storage 1018 and non-removable storage 1020.

Computer storage media includes volatile, nonvolatile, removable, and non-removable media implemented in any method or technology for storage of information such as computer readable instructions, data structures, program modules, or other data. Memory 1014, removable storage 1018, and non-removable storage 1020 are all examples of computer storage media. Computer storage media includes, but is not limited to, RAM, ROM, EEPROM, flash memory or other memory technology, CDROM, digital versatile disks (DVD) or other optical storage, magnetic cassettes, magnetic tape, magnetic disk storage or other magnetic storage devices, or any other medium which can be used to store the desired information and which can accessed by device 1000. Any such computer storage media may be part of device 1000.

Device 1000 may also contain communications connection(s) 1022 that allow the device to communicate with other devices. Communications connection(s) 1022 is an example of communication media. Communication media typically embodies computer readable instructions, data structures, program modules, or other data in a modulated data signal such as a carrier wave or other transport mechanism and includes any information delivery media. The term “modulated data signal” means a signal that has at least one of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Device 1000 may also have input device(s) 1024 such as keyboard, mouse, pen, voice input device, touch input device, etc. Output device(s) 1026 such as a display, speakers, printer, etc. may also be included. All these devices are well known in the art and need not be discussed at length here.

The methods that have been described can be computer-implemented on the device 1000. A computer-implemented method is desirably realized at least in part as at least one programs running on a computer. The programs can be executed from a computer-readable medium such as a memory by a processor of a computer. The programs are desirably storable on a machine-readable medium, such as a floppy disk or a CD-ROM, for distribution and installation and execution on another computer. The program or programs can be a part of a computer system, a computer, or a computerized device.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

1. A program storage device, comprising:
program instructions executable by a processing device to perform operations for providing continuous or near-continuous availability in an N-way shared-nothing cluster system, the operations comprising:
assigning cluster application data space partitions to each node in a cluster; and
partitioning and binding internal architecture to the cluster application data space partitions assigned to the node.

2. The program storage device of claim 1 further comprising:
performing cluster-integrity protection; and
performing a failover and recovery protocol based upon the assigned partitions and the partitioned and bound internal architecture.

3. The program storage device of claim 2, wherein the N-way shared-nothing cluster system includes shared storage for providing a logical shared-nothing cluster system, wherein the failover and recovery protocol comprises accessing by at least one node in the cluster system logs and data space partitions of the failed node in the cluster system.

4. The program storage device of claim 2, wherein the N-way shared-nothing cluster system includes a plurality of nodes, each of the plurality of nodes owning a storage device for providing a physical shared-nothing cluster system, wherein the failover and recovery protocol comprises providing a surviving node synchronous log record access to logs of a failed node and replicating the log of the failed node in storage owned by the surviving node.

5. The program storage device of claim 1, wherein the partitioning and binding internal architecture to the cluster application data space partitions assigned to the node comprises partitioning internal system architecture and structures of a node in accordance with partitioned application data space of the node.

6. The program storage device of claim 5, wherein the partitioning internal system architecture and structures includes partitioning of transaction queues, buffer cache and associated synchronization primitives of a node in accordance with partitioned application data space of the node.

7. The program storage device of claim 2, wherein the performing cluster-integrity protection further comprises:
maintaining nodes in a cluster membership during cluster recovery unless the node fails or is dropped from the cluster by administrative action;
monitoring cluster members participating in the recovery protocol by a leader determined from the nodes in the cluster; and
monitoring the leader by the cluster members participating in the recovery protocol.

8. The program storage device of claim 2, wherein the recovery protocol further comprises:
initiating cluster membership validation and teardown of affected file sets;
updating cluster membership based upon initiation of cluster membership validation and concurrently fencing rogue servers;
committing the cluster membership update; and
failing over affected partitions to at least one surviving node.

9. A computing device for use in a N-way shared-nothing cluster system, comprising:
memory for storing data therein; and
a processor, coupled to the memory, the processor configured to perform an operation by assigning cluster application data space partitions, and partitioning and binding internal architecture to the cluster application data space partitions.

10. The computing device of claim 9, wherein the processor is further configured to perform cluster-integrity protection and to perform a failover and recovery protocol based upon the assigned partitions and the partitioned and bound internal architecture.

11. The computing device of claim 10, wherein the processor performs a failover and recovery protocol by accessing logs of a failed node and replicating the log of the failed node.

12. The computing device of claim 9, wherein the processor partitions and binds internal architecture to cluster application data space partitions by partitioning internal system architecture and structures in accordance with partitioned application data space.

13. The computing device of claim 10, wherein the processor performs cluster-integrity protection by maintaining nodes in a cluster membership during cluster recovery unless the node fails or is dropped from the cluster by administrative action, monitoring cluster members participating in the recovery protocol by a leader determined from the nodes in the cluster and monitoring the leader by the cluster members participating in the recovery protocol.

14. The computing device of claim 10, wherein the processor performs the failover and recovery protocol by initiating cluster membership validation and teardown of affected file sets, updating cluster membership based upon initiation of cluster membership validation and concurrently fencing rogue servers, committing the cluster membership update and carrying out failing over of affected partitions to at least one surviving node.

15. A method providing continuous or near-continuous availability in an N-way shared-nothing cluster system, comprising:
assigning cluster application data space partitions to each node in a cluster; and
partitioning and binding internal architecture to the cluster application data space partitions assigned to the node.

16. The method of claim 15 further comprising:
performing cluster-integrity protection; and
performing a failover and recovery protocol based upon the assigned partitions and the partitioned and bound internal architecture.

17. The method of claim 16, wherein the N-way shared-nothing cluster system includes shared storage for providing a logical shared-nothing cluster system, wherein the failover and recovery protocol comprises accessing by at least one node in the cluster system logs and data space partitions of the failed node in the cluster system.

18. The method of claim 16, wherein the N-way shared-nothing cluster system includes a plurality of nodes, each of the plurality of nodes owning a storage device for providing a physical shared-nothing cluster system, wherein the failover and recovery protocol comprises providing a surviving node synchronous log record access to logs of a failed node and replicating the log of the failed node in storage owned by the surviving node.

19. The method of claim 15, wherein the partitioning and binding internal architecture to the cluster application data space partitions assigned to the node comprises partitioning internal system architecture and structures of a node in accordance with partitioned application data space of the node.

20. The method of claim 19, wherein the partitioning internal system architecture and structures includes partitioning of transaction queues, buffer cache and associated synchronization primitives of a node in accordance with partitioned application data space of the node.

21. The method of claim 16, wherein the performing cluster-integrity protection further comprises:
maintaining nodes in a cluster membership during cluster recovery unless the node fails or is dropped from the cluster by administrative action;
monitoring cluster members participating in the recovery protocol by a leader determined from the nodes in the cluster; and
monitoring the leader by the cluster members participating in the recovery protocol.

22. The method of claim 16, wherein the recovery protocol further comprises:
initiating cluster membership validation and teardown of affected file sets;
updating cluster membership based upon initiation of cluster membership validation and concurrently fencing rogue servers;
committing the cluster membership update; and
failing over affected partitions to at least one surviving node.
